(19) United States
(12) Patent Application Publication
(10) Pub. No.: US 2023/0129860 A1
(43) Pub. Date: Apr. 27, 2023

(54) SUBSTRATES AND SPACERS FOR USE WITHIN A THREE-DIMENSIONAL PRINTING RESERVOIR ASSEMBLY

(71) Applicant: SprintRay Inc., Los Angeles, CA (US)

(72) Inventors: Amir Mansouri, Los Angeles, CA (US); Huijian Tian, Los Angeles, CA (US); Hossein Bassir, Los Angeles, CA (US); Jing Zhang, Los Angeles, CA (US)

(21) Appl. No.: 17/975,024

(22) Filed: Oct. 27, 2022

Related U.S. Application Data
(60) Provisional application No. 63/272,628, filed on Oct. 27, 2021.

(51) Int. Cl. B29C 64/245; B33Y 30/00

(52) U.S. Cl. CPC B29C 64/245; B33Y 30/00

(57) ABSTRACT

The present invention concerns a system and reservoir assembly for three-dimensional (3D) printing. The reservoir assembly includes a top frame that may be filled with liquid material, and a tensioned film being held underneath the top frame. The tensioned film may be air permeable and flexible. A bottom frame is coupled to the top frame and secures a transparent or semi-transparent rigid substrate. A tempered glass substrate is sandwiched between the tensioned film secured to the top frame and the transparent or semi-transparent rigid substrate secured to the bottom frame. One or more spacers may be placed between the rigid substrate and the tempered glass substrate to form air gaps therebetween.

### CROSS-REFERENCE TO RELATED APPLICATIONS

This application claims priority to U.S. Provisional Application No. 63/272,628 filed Oct. 27, 2021, the entire contents of which are hereby fully incorporated herein by reference for all purposes.

### TECHNICAL FIELD OF THE INVENTION

The present invention generally relates to an apparatus, system and method for three-dimensional (3D) printing, including substrates for use within a three-dimensional printing reservoir assembly.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Three-dimensional printing is a process to form a three-dimensional object from computer-aided design (CAD) data. Different from traditional processes such as casting and cutting, 3D printing utilizes adding instead of removing materials to create the solid object which could have a complex shape or geometry. This process is also known as additive manufacturing (AM), rapid prototyping or solid freeform fabrication. The machine to perform this process is called a 3D printer.

Basically, 3D printing is achieved by building a 3D object layer by layer from a particular material such as powdered metal, liquid of a prepolymer or any other appropriate materials. Each of these layers is a thin slice which represents the cross-section of the eventual object. It is generated by the process similar to the regular 2D printing in a single plane (x and y dimensions). All layers are laid over one another successively in z dimension. With the number of these layers accumulated, a 3D object is formed.

There are numbers of different technologies developed based on different materials and ways to form layers, for example, Fused Deposition Modeling (FDM), Stereolithography (SLA), 3D Inkjet Powder (3DP), Selective Laser Sintering (SLS).

Stereolithography is one of the most precise 3D printing techniques in the market. The principle of SLA is to create a 3D object by successively solidifying thin layers of liquid material which is curable by a light with a specific wavelength, starting from the bottom layer to the top layer. A conventional SLA system comprises a resin tank filled with a predetermined volume of photosensitive material or resin, an elevating platform immersed in the resin tank, and a light source, such as a projector or a laser, for generating curing light to solidify a plurality of thin layers with a given layer thickness to form a 3D object which is attached on the elevating platform.

The entire Stereolithography process may be broken down into the following steps: resin filling, light exposure, separation of the solidified section from the vat or reservoir and replenishing the photosensitive resin. Due to the inefficient material replenishment and separation processes, most conventional SLA processes have a slow fabrication speed. Also, separation of the polymerized cross-sections from the reservoir creates a huge suction force that can lead into fracture of the fabricated sections during the course the printing process.

Accordingly, it would be highly desirable to develop an SLA three-dimensional printing which is capable of increasing the fabrication speed of the 3D object and enhancing the quality of the 3D object while being cost effective. It is to these ends that the present invention has been developed.

### BRIEF DESCRIPTION OF THE DRAWINGS

The apparatus, system, and method for use in stereolithography three-dimensional printing as disclosed herein are further described in terms of exemplary embodiments. These exemplary embodiments are described in detail with reference to the drawings, which have not necessarily been drawn to scale in order to enhance their clarity and improve understanding of the various embodiments of the invention. Furthermore, elements that are known to be common and well understood to those in the industry are not depicted in order to provide a clear view of the various embodiments of the invention. These embodiments are non-limiting exemplary embodiments, in which like reference numerals represent similar structures throughout the several views of the drawings. The drawings that accompany the detailed description can be briefly described as follows:

FIG. 1 shows a system for use in three-dimensional printing in accordance with exemplary embodiments hereof;

FIG. 2 shows aspects of a reservoir assembly in accordance with exemplary embodiments hereof;

FIGS. 3-5 shows aspects of a tempered glass substrate for use in a reservoir assembly in accordance with exemplary embodiments hereof;

FIG. 6 shows an exploded view of a reservoir assembly in accordance with exemplary embodiments hereof;

FIG. 7 is a top perspective view of a reservoir assembly in accordance with exemplary embodiments hereof;

FIG. 8 is a bottom perspective view of a reservoir assembly in accordance with exemplary embodiments hereof;

FIG. 9 is a cross-sectional view of a reservoir assembly in accordance with exemplary embodiments hereof;

FIG. 10 is a cross-sectional view of a reservoir assembly in accordance with exemplary embodiments hereof;

FIG. 11 is a cross-sectional view of a reservoir assembly in accordance with exemplary embodiments hereof;

FIGS. 12-14 show aspects of permeable substrates in accordance with exemplary embodiments hereof;

FIG. 15 is a top perspective view of a reservoir assembly in accordance with exemplary embodiments hereof;

FIG. 16 is a cross-sectional view of a reservoir assembly in accordance with exemplary embodiments hereof;

FIG. 17 is a close-up view of a portion of a reservoir assembly in accordance with exemplary embodiments hereof;

FIG. 18 shows aspects of spacer members in accordance with exemplary embodiments hereof; and

FIGS. 19-20 show aspects of spacer members in accordance with exemplary embodiments hereof.

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized, and changes may be made without departing from the scope of the invention. Wherever possible, the same reference numbers are used in the drawings and the following description to refer to the same or similar elements.

In the following detailed description, numerous specific details are set forth by way of examples in order to provide a thorough understanding of the relevant teachings. However, it should be apparent to those skilled in the art that the present teachings may be practiced without such details. In other instances, well known structures, components and/or functional or structural relationship thereof, etc., have been described at a relatively high-level, without detail, in order to avoid unnecessarily obscuring aspects of the present teachings.

Throughout the specification and claims, terms may have nuanced meanings suggested or implied in context beyond an explicitly stated meaning. Likewise, the phrase “in one embodiment/example” as used herein does not necessarily refer to the same embodiment and the phrase “in another embodiment/example” as used herein does not necessarily refer to a different embodiment. It is intended, for example, that claimed subject matter include combinations of example embodiments in whole or in part.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and or steps. Thus, such conditional language is not generally intended to imply that features, elements and or steps are in any way required for one or more embodiments, whether these features, elements and or steps are included or are to be performed in any particular embodiment.

The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present. The term “and or” means that “and” applies to some embodiments and “or” applies to some embodiments. Thus, A, B, and or C can be replaced with A, B, and C written in one sentence and A, B, or C written in another sentence. A, B, and or C means that some embodiments can include A and B, some embodiments can include A and C, some embodiments can include B and C, some embodiments can only include A, some embodiments can include only B, some embodiments can include only C, and some embodiments include A, B, and C. The term “and or” is used to avoid unnecessary redundancy. Similarly, terms, such as “a, an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

While exemplary embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the invention or inventions disclosed herein. Accordingly, the following detailed description does not limit the disclosure. Instead, the proper scope of the disclosure is defined by the appended claims.

For purposes of this disclosure, the terms “upper”, “lower”, “right”, “left”, “rear”, “front”, “vertical”, “horizontal” and derivatives thereof shall relate to the invention as oriented in the figures. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics related to the embodiments disclosed herein are not to be considered as limiting, unless the claims expressly state otherwise.

As used in this disclosure, the term “comprise” and variations of the term, such as “comprising” and “comprises,” are not intended to exclude other additives, components, ingredients or steps.

The present disclosure relates to, among other things, an apparatus, system, and method for use in three-dimensional (3D) printing for building a 3D object. The present disclosure also relates to elements for use with a 3D to improve the 3D printing processes. Exemplary embodiments of the present disclosure are described with reference to the drawings for illustration purposes and are not intended to limit the scope of the present disclosure.

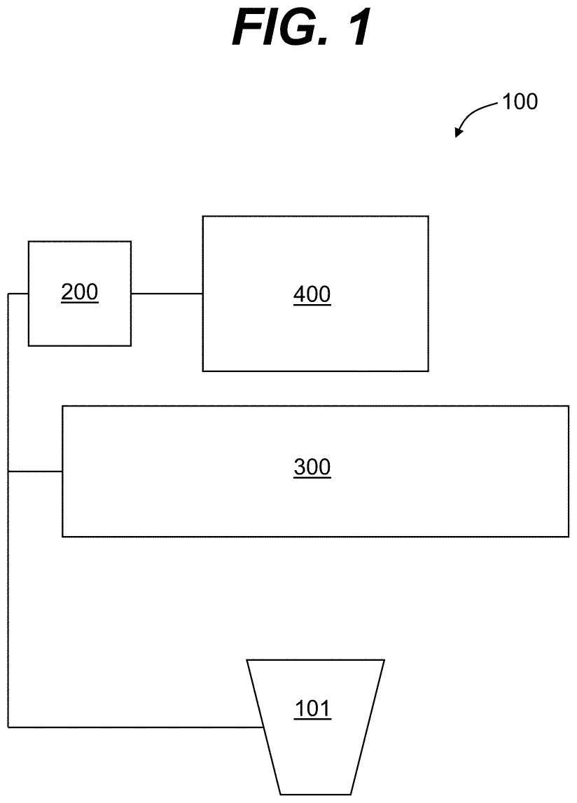

FIG. 1 shows elements of a 3D printer 100 as is known in the art, comprising for example, a reservoir assembly 300 for retaining photosensitive material (the printing solution), a printing platform 400 submersible into the tank assembly 300 and upon which photosensitive material may be cured to form the desired object, a light source 101 for illuminating individual layers of photosensitive material and to cure the layers onto the printing platform 400, and a controller 200 for storing the geometric profile of the three-dimensional object being printed and for controlling the various assemblies and mechanisms during the 3D printing process.

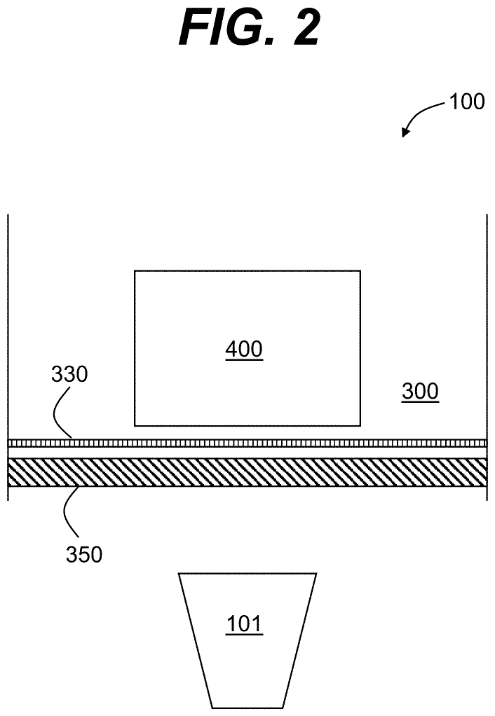

In addition as shown in FIG. 2, the reservoir assembly 300 may include a bottom plate 350 (also referred to herein as a rigid substrate) (preferably transparent) towards the bottom of the reservoir 300, and a flexible film 330 (also referred to herein as a tensioned film) (preferably transparent) covering or in close proximity to an upper surface of the bottom plate 350. Also, depending on the viscosity of the photosensitive material, dispensing mechanisms (such as scrapers) for providing a layer of photosensitive material onto the flexible film 330 may be implemented.

During the 3D printing process, the printing platform 400 is submerged into the reservoir assembly 300 from above and placed to within close proximity to the flexible film 330 and the bottom plate 350. A thin layer of the photosensitive material is provided between the flexible film 330 and the printing platform 400, and subsequently, illuminated by the light source 101. This in turn cures the layer of photosensitive material and solidifies it onto the printing platform 400, with each solidified layer including a profile in accordance with a geometric profile of the three-dimensional object being printed (e.g., stored on the controller 200).

After the caring of each individual layer, the flexible film 330 and/or the bottom plate 350 of the reservoir assembly 300 must be separated from the cured material without damaging, deforming, or otherwise adversely affecting the cured layer(s). After separation, a new layer of photosensitive material is provided between the flexible film 330 and the printing platform 400. The new layer is then cured onto the previously cured layer on the printing platform 400 and separated from the flexible film 330 and the bottom plate 350. This process continues until the desired three-dimensional object is formed.

As will be described herein, the current invention provides one or more additional substrate(s) 500 for use within the reservoir assembly 300. In some embodiments, the additional substrates 500 are implemented between an upper surface of the bottom plate 350 and a lower surface of the flexible film 330. In some embodiments, the additional substrates 500 provide a flexible smooth surface between the bottom plate 350 and the flexible film 330 to aid in the separation process between the flexible film 330 and the layers of solidified material cured onto the printing platform 400.

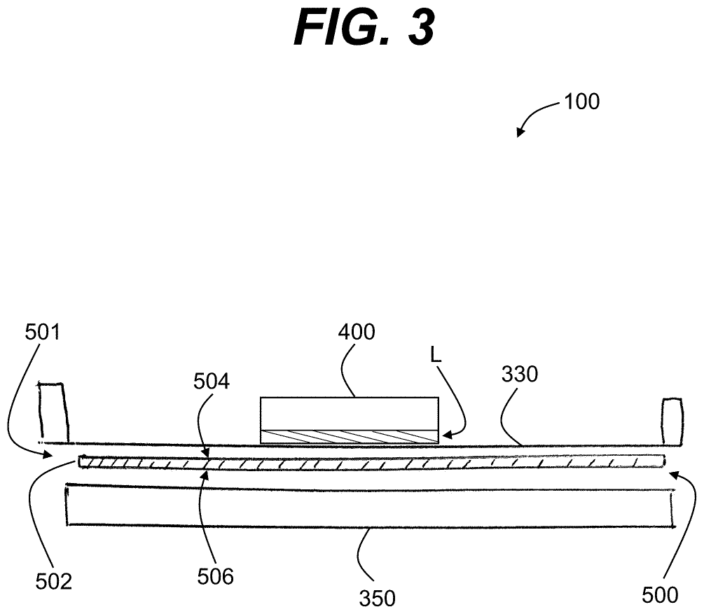

In some embodiments as shown in FIG. 3, the additional substrate(s) 500 includes one or more flexible substrates 501. For the purposes of this specification, the flexible substrates 501 will primarily be described as tempered glass substrates 502. However, it is understood that in any of the embodiments described herein, the sheet of tempered glass 502 may be replaced with (or used in combination with) a sheet of a different suitable material, e.g., annealed glass, plastic, other suitable materials, and any combinations thereof. For example, in some embodiments, a thin sheet of semirigid (e.g., semiflexible) plastic (preferably transparent) may be used instead of (or in addition to) the sheet of tempered glass 502. In this case, it may be preferable that the sheet of plastic provides similar mechanical characteristics as the tempered glass 502, especially with respect to rigidity, flexibility, and elasticity. As is known in the art, glass (including tempered glass and annealed glass) is a perfectly elastic material and does not exhibit permanent deformation until breakage. In addition, flexural strength (also referred to as bending strength) is a material property defined as the stress in a material just before the material yields in a flexure test. In some embodiments, the tempered glass includes a flexural strength of about 120-200 N/mm². Example semirigid plastics that may be used include, but are not limited to, Polycarbonate, Acrylic, Acrylonitrile Butadiene Styrene (ABS), Polyethylene, Polyethylene terephthalate, fluorinated ethylene propylene, Epoxy, Polyurethane, Polyvinyl Chloride, any types of thermoplastics, other suitable plastics, and any combinations thereof.

In some embodiments, as shown in FIG. 3, a tempered glass substrate 502 is located between the transparent rigid substrate 350 and the tensioned film 330. The tempered glass substrate 502 includes an upper surface 504 (e.g., facing the lower surface of the tensioned film 330), and a lower surface 506 (e.g., facing the upper surface of the rigid substrate 350). While a single substrate of tempered glass 502 is shown in FIG. 3, it is understood that multiple substrates of tempered glass 502 may be provided (e.g., stacked).

In some embodiments, the upper surface 504 and the lower surface 506 of the tempered glass substrate 502 are smooth, thereby providing a smooth interface between the tempered glass substrate 502 and the tensioned film 330 above and a smooth interface between the tempered glass substrate 502 and the rigid substrate 350 below. In this way, the tempered glass substrate 502 provides a flat upper surface 504 and a flat lower surface 506.

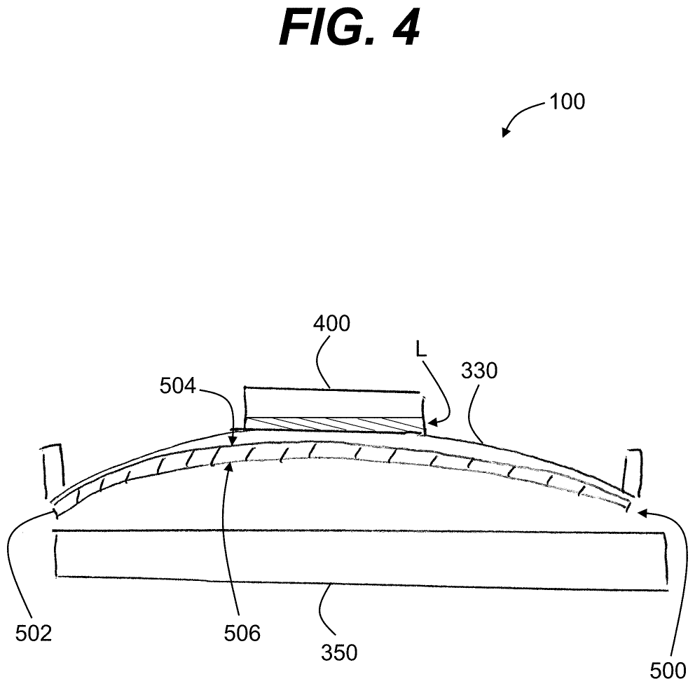

In some embodiments as shown in FIG. 4, the tempered glass substrate 502 is flexible so that it may flex or otherwise deform during the separation process of the layers of solidified photosensitive material L cured onto the printing platform 400 and the tensioned film 330. It is preferable that the tempered glass substrate 502 be sufficiently strong and flexible so that it does not crack, break, or otherwise experience any undesirable physical effects during the separation process.

In some embodiments as shown in FIG. 4, the tempered glass substrate 502 may bow (e.g., flex) upwards due to the suction forces between the lower surface of the tensioned film 330 and the upper surface 504 of the tempered glass substrate 502 and the suction forces between the upper surface of the tensioned film 330 and the cured layer L of solidified photosensitive material on the printing platform 400.

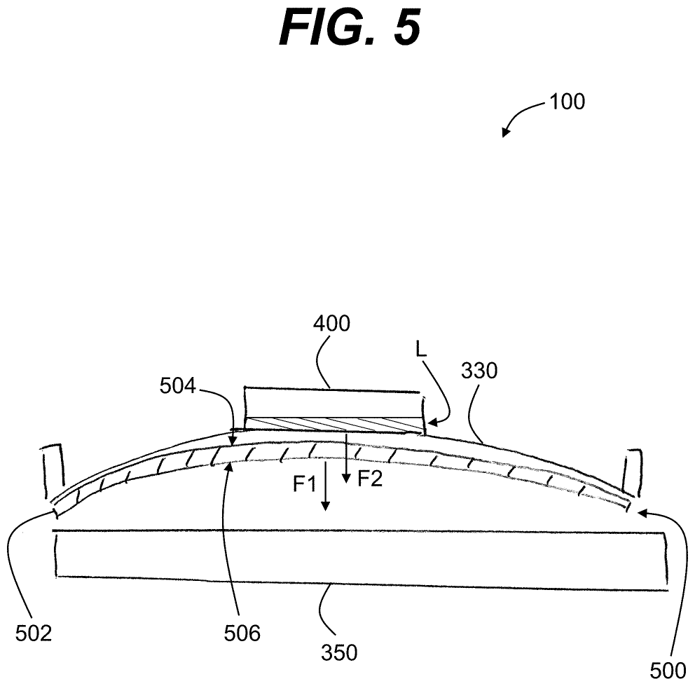

As shown in FIG. 5, as the tempered glass substrate 502 bows upward, its tendency to return to its original flat shape (due to its sufficient rigidity) will set up downward forces F1 within the tempered glass substrate 502 pulling it downward. In addition, due to the suction force between the upper surface 504 of the tempered glass substrate 502 and the lower surface of the tensioned film 330, a portion of the forces F1 will extend to the tensioned film 330 pulling it downward as represented by forces F2. Given the elasticity of the tensioned film 330, these downward forces F2 will facilitate the peeling of the tensioned film 330 from the lower surface of the cured layer L of photosensitive material on the printing platform 400, thereby aiding in the separation between the tensioned film 300 and the layers L of cured photosensitive material on the printing platform 400 during the separation process.

In some embodiments, it may be preferable to reduce the suction forces between the upper surface 504 of the tempered glass substrate 502 and the lower surface of the tensioned film 330. It also may be preferable to provide an opportunity for gas (e.g., air or oxygen) to be introduced to the lower surface of the tensioned film 330 such that the gas may penetrate through the tensioned film 330 from its bottom side to its top side. In this way, with a small amount of gas present at the top surface of the tensioned film 330, the resin at the top surface of the tensioned film 330 may not become fully polymerized during the curing process, and a thin layer of photosensitive resin may still remain as liquid between the newly cured layer of the 3D object (layer L) and the tensioned film 330, thereby reducing the suction force for separating the cured layer of the 3D object from the tensioned film 330.

Accordingly, in some embodiments the upper surface 504 of the tempered glass substrate 502 is smooth when in its flat position (as shown in FIG. 3) and textured when in its upwardly bowed position. For example, in some embodiments, the tempered glass substrate 502 may include micro-channels and/or micro-cracks in its upper surface 504 that may become spread during the bowing of the substrate 502. Once spread, the micro-cracks may release small amounts of gas (e.g., oxygen and/or air) to the bottom surface of the tensioned film 300, thereby reducing the suction force between the tensioned film 330 and the tempered glass substrate 502.

In addition, the gas released by the tempered glass substrate 502 upon bowing may then pass through the tensioned film 330 from its bottom side to its top side, thereby facilitating a thin layer of uncured photosensitive resin directly above the film 330 as described above. This in turn reduces the suction forces between the layer L of cured photosensitive material and the tensioned film 330 thereby aiding in the separation process.

It is preferable that the micro-channels and/or micro-cracks in the upper surface 504 of the tempered glass substrate 502 do not reduce the rigidity or strength of the substrate 502. It also is preferable that the micro-channels and/or micro-cracks do not adversely increase in size during the bowing of the substrate 502 such that the substrate 502 is not damaged or worn during its use. In general, it is preferable that when the substrate 502 is in its flat position, the micro-channels and/or micro-cracks are essentially closed so that the upper surface 504 of the substrate 502 is flat and smooth, and that when the substrate 502 is in its upwardly bowed position, the micro-channels and/or micro-cracks are open to provide the benefits described herein.

Exemplary embodiments and details of the current invention will next be described by way of several detailed examples detailing use of the additional substrates 500 with particular 3D printer systems. The examples provided below are chosen to illustrate various embodiments and implementations of the invention, and those of ordinary skill in the art will appreciate and understand, upon reading this description, that the examples are not limiting and that the additional substrates 500 may be used in different ways and with any type(s) of 3D printers that may benefit from the substrates 500. It also is understood that details of any embodiments described in any examples may be combined in any way to form additional embodiments that are all within the scope of the invention.

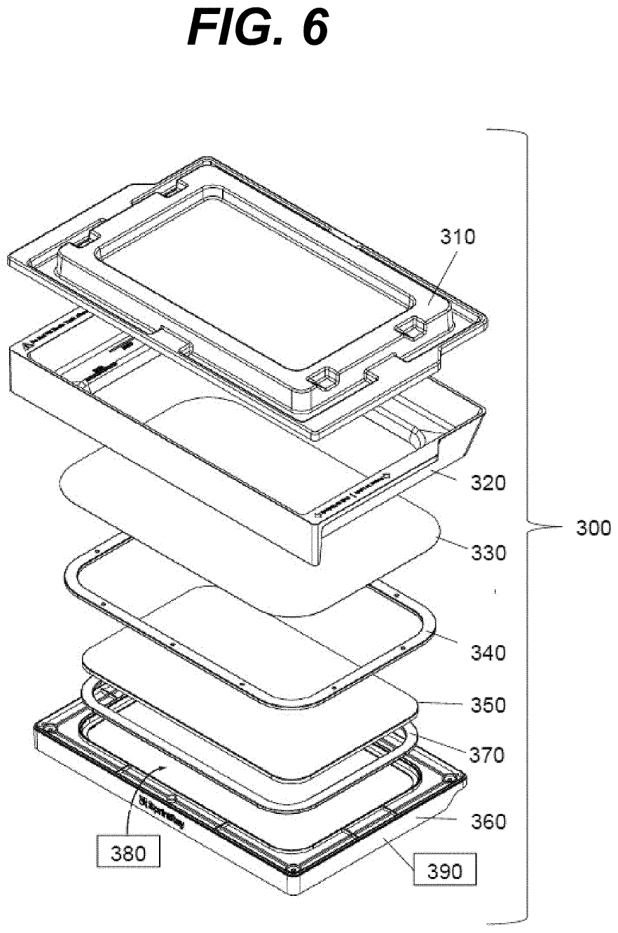

Turning now to FIG. 6, an exploded perspective view of a reservoir assembly of an exemplary 3D printing system according to the present invention is shown. More specifically, FIG. 6 depicts reservoir assembly 300, a lid 310, a top frame 320, a tensioned film 330, a tensioning ring 340, a rigid substrate 350, and a bottom frame 360 coupled with each other from top to bottom. As will be described in other sections, tempered glass substrate 502 may be located between the tensioned film 330 and the rigid substrate 350.

In some embodiments, the tensioned film 330 (for example, and without limitation, a permeable, non-stick, and elastic tensioned film), may be wrapped around the tensioning ring 340 and secured thereto. In other embodiments, tensioning and securing tensioned film 330 to top frame 320 may comprise using high performance elastic double-sided adhesives to secure the tensioned film 330 to the tensioning ring 340 or another portion of the top frame 320. Because in some exemplary embodiments supplying a gas through the permeable tensioned film 330 may be advantageous, the reservoir assembly 300 may further comprise a gas supplying module 390 having a gas outlet (not shown) connected thereto for supplying gas, such as air or oxygen, to the bottom of the tensioned film 330.

Typically, as discussed above, the additional substrate 500 (e.g., the tempered glass substrate 502) may be disposed between the permeable tensioned film 330 and the rigid substrate 350 of the bottom frame 360 in a manner so that the permeable tensioned film 330 is suspended above the tempered glass substrate 502.

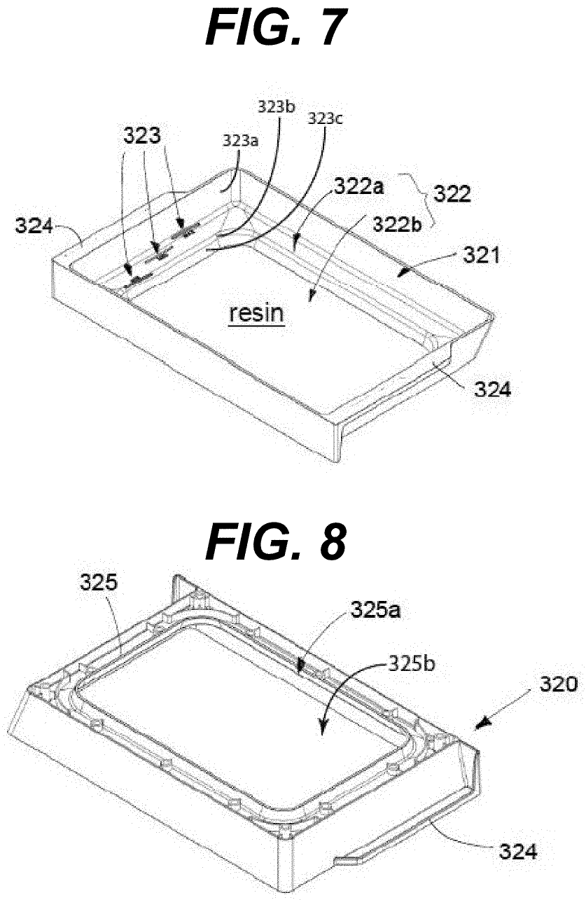

Accordingly, a reservoir assembly 300 for use in three-dimensional printing may typically comprise of a top frame 320 having a cavity (see for example cavity 322 in FIG. 7) with an aperture (see for example aperture 325b in FIG. 8) defined on a bottom edge of the top frame 320, the cavity 322 configured to be at least partially filled with a photosensitive liquid; a permeable tensioned film 330 stretchily coupled to the aperture 325b so as to hold the photosensitive liquid within the cavity of the top frame 320; a bottom frame 360 including a transparent or semi-transparent rigid substrate 350, the bottom frame 360 configured to register with the top frame 320; and an additional substrate 500 (e.g., a tempered glass substrate 502) disposed between the permeable tensioned film 330 and the rigid substrate 350 of the bottom frame 360 in a manner so that the permeable tensioned film 330 is suspended above the substrate 502.

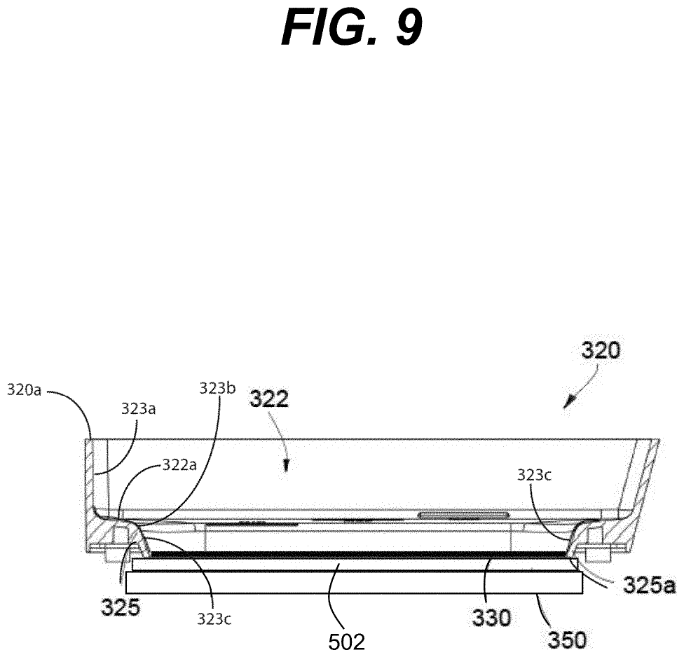

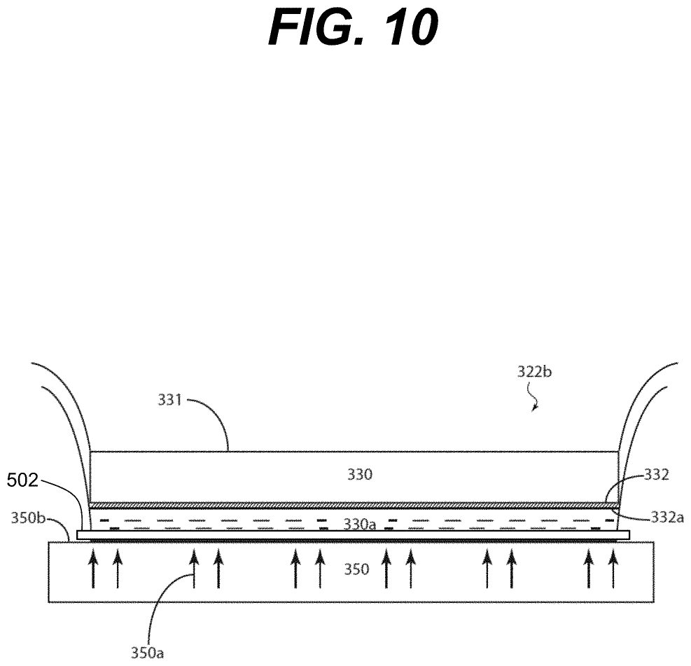

FIG. 7 is a top perspective view of a top frame of a reservoir assembly according to an exemplary embodiment of the present invention; FIG. 8 is a bottom perspective view thereof; FIG. 9 is a cross-sectional view thereof, and FIG. 10 is a diagram showing an exemplary cross-section of top frame 320 coupled to a portion of bottom frame 360 of reservoir assembly 300.

FIGS. 7-10 depict the top frame 320, wherein the top frame 320 is arranged to fill with and hold a predetermined liquid material, such as resin or any other material that is photosensitive and suitable for 3D printing. The top frame 320, together with the tensioned film 330, creates a container for the liquid material to reside in during the printing process. The top frame 320 has a top opening 321 and a cavity 322, wherein the cavity 322 has a depth difference between the peripheral portion and the central portion, so that the cavity 322 of top frame 320 defines a peripheral shallow portion 322a and a center deep portion 322b. This design, in accordance with some exemplary embodiments of the present invention, defines a region (for example, the center deep portion 322b within cavity 322) for the liquid material to easily accumulate in, which facilitates efficient use of available liquid material.

In exemplary embodiments of the present invention, tensioned film 330 may be a Selectively Textured Elastomeric Membrane (STEM) film that has a non-stick surface. In some exemplary embodiments, the STEM film may include Polymethylpentene (PMP). The material is commonly referred to as TPX®, which is a trademark of Mitsui Chemicals. The material may be typically used in gas permeable packing industry. Polymethylpentene melts at ≈235° C., and it has a density of about 0.84 g/cm³. The gas permeability of TPX® may be around 30 Barrer. In some exemplary embodiments, a PMP material is transparent, but the surface of the PMP material may be textured to provide an improved non-stick property.

Implementation of a STEM film for tensioned film 330 may provide several advantages. Typical Stereolithography systems either use flexible films (PTFE) that flexes and causes the separation of the polymerized sections or an oxygen-permeable gel type material, e.g., Polydimethylsiloxane (PDMS), that creates the inhibition of the polymerization process at its surface and leads to a minimal separation force. In some exemplary embodiments of the present invention, however, tensioned film 330 may be a STEM film that integrates the advantages from both PTFE films as well as oxygen-permeable gel type materials such as PDMS. For example, and without limiting the scope of the present invention, tension film 330 may include a STEM film that includes PMP so as to provide a greater gas permeability that creates a minimal suction force; moreover, a STEM film that includes PMP flexes as a part arm (i.e., a platform of system 100 such as exemplary platform 400) pulls up and the part (being printed or fabricated using system 100) starts to separate from the part arm. The STEM film that includes PMP generally includes a high yield stress which makes it rigid while allowing for fast energy recovery. The PMP material also allows the molecules of oxygen to pass through the tensioned film 330 to create an anti-cure effect that is similarly desirable.

In some exemplary embodiments as shown in FIG. 10, in order to fully benefit from both flexibility and gas permeability, a media layer 330a may be employed. For example, and without limiting the scope of the present invention, in some exemplary embodiments tensioned film 330 is a STEM film comprising PMP that is suspended over a media layer 330a, wherein the media layer 330a is disposed between a top surface 504 of the tempered glass substrate 502 and a bottom surface 332a of the tensioned film 330. Notably, without media layer 330a, a secondary suction force between tensioned film 330 and rigid substrate 350 may make separation more stringent and thus slow down the process and efficiency of system 100.

In some exemplary embodiments, media layer 330a could be in the form of a gas. For example, and without limiting the scope of the present invention, the gas may include air, nitrogen, or oxygen. In some exemplary embodiments, media layer 330a could be in the form of a liquid. For example, and without limiting the scope of the present invention, the liquid may include water, or oil. In some exemplary embodiments, media layer 330a could be in the form of a semi-liquid material. For example, and without limiting the scope of the present invention, the semi-liquid material may include a gel, or any other rubber like materials. In exemplary embodiments, employing medial layer 330a may be achieved through the assembly process by, for example and without limiting the scope of the present invention, leaving a desired clearance between a top surface 350b of the transparent rigid substrate 350 and a bottom surface 332 of the tensioned film 330, and/or between a top surface 504 of the tempered glass substrate 500 and the bottom surface 332 of the tensioned film 330.

In exemplary embodiments, a typical thickness of media layer 330a may be between 0.05 mm to 0.25 mm. Notably, too great of a thickness may affect accuracy of some Stereolithography-based 3D printing systems, whereas too small of a thickness may not significantly facilitate the separation process. This may be apparent upon illustration of what occurs during the separation process: Before the projection starts at a specific layer, a previously polymerized section or even a bottom surface of an elevator platform and a top surface 331 of the tension film 330 will sandwich a thin layer of liquid material such as a photosensitive resin within cavity 322 of top frame 320. Because of the pressure from the elevator platform, the tensioned film 330, directly suspended over media layer 330a, will be pushed towards the tempered glass substrate 502 to contact or substantially contact the substrate 502. Due to the existence of the media layer 330a which is usually soft and compressible, the pressure caused by the tensioned film 330 being pushed towards the tempered glass substrate 502 will deform the media layer 330a at least to the extent of an area covered by the platform or previously polymerized section below the platform. In some exemplary embodiments, media layer 330a may be configured such that during its deformation caused by the tensioned film 330 being pushed towards the tempered glass substrate 502, other areas of the media layer 330a that are not covered by the platform or previously polymerized section below the platform of the system 100, retain an original geometry. In any event, in some exemplary embodiments of the present invention, the thickness difference between the portion of the media layer 330a that is compressed and the non-compressed media layer may create a curvature on the tensioned film 330 having a tangent angle of approximately between 2°-4°. Then, during the separation process, when the pressure is released, the tensioned film 330 and the media layer 330a tend to recover their original states. The detachment of the tensioned film 330 from the media layer 330a or the tempered glass substrate 502 first starts at the border (curved area), and then propagates towards the center until completely separated. The curvature caused by the difference in height helps to convert a separation in a normal direction into a peeling process, with the peeling process much easier to realize in terms of the magnitude of the force. When air, or oxygen, is introduced through the tensioned film 330 to the bottom of the liquid material, the liquid material is not fully polymerized in this area. This results in a thin layer of liquid resin between the polymerized sections and the tensioned film 330 which may reduce the suction forces of the polymerized section for the separation of the polymerized sections from the reservoir assembly 300. Accordingly, in some exemplary embodiments, the reservoir assembly 300 may further comprise a gas supplying module 390 having a gas outlet connected thereto for supplying gas, such as air or oxygen, to the bottom of the tensioned film 330.

As mentioned above, the tensioned film 330 is coupled at the bottom of the cavity 322 of the top frame 320 to retain the liquid material therein, wherein the liquid material cannot pass through the tensioned film 330 from its top surface to its bottom surface. The tension and strength of the tensioned film 330 should be strong enough to hold the liquid material within the cavity 322 of the top frame 320 without penetrating through the tensioned film 330 to the rigid substrate 350 and bottom frame 360. On the other hand, the air is able to pass through the tensioned film 330 due to the gas permeability of the tensioned film 330, wherein the air is guided to penetrate through the tensioned film 330 from the bottom surface to the top surface. Therefore, the oxygen in the air will prevent polymerization at the top surface of the tensioned film 330. As mentioned above, this will reduce the suction force as the liquid material is not fully polymerized at the bottom of the reservoir, and therefore, reduce the adhesion force between the newly solidified section and the top surface of the tensioned film 330. In this way, the 3D object being formed may be easily separated from the tensioned film 330 in a manner that prevents surface damage of the 3D object during the separation process.

Tensioned film 330 is preferably retained in a tensioned manner for several reasons. Primarily, PMP, PPT, PPE or any other material with properties suitable for tensioned film 330 will typically allow a better diffusion of oxygen molecules when the material is stretched. In some exemplary embodiments, a thickness of a tensioned film 330 comprising PMP may be between 0.05 mm and 1 mm when stretched. Stretching or tensioning also creates a flat surface while polymerization happens. Tensioning may be achieved by various methods without limiting the scope of the present invention, however, in some exemplary embodiments, structural components may facilitate tensioning. For example, a structural design of the bottom section of the top frame 320 as shown in FIG. 4 may include features or characteristics that facilitate a stretched, tensioned configuration of tensioned film 330.

In exemplary embodiments, transparent rigid substrate 350 may include a piece of glass, or any other optically clear flat material, such as but not limited to a polycarbonate, acylates panel that has a flat transparent surface. The transparent rigid substrate 350 may be arranged or positioned underneath the tempered glass substrate 502 beneath the tensioned film 330 and configured to support the tensioned film 330 (via the tempered glass substrate 502) when a 3D object is being printed thereon. The tensioned film 330 may sit directly on tempered glass substrate 502 on top of the rigid substrate 350 due to the weight of the 3D object.

Preferably, although not necessarily, air can flow freely between the bottom of the tensioned film 330 and the rigid substrate 350 and/or the tempered glass substrate 502 so that oxygen in the air can penetrate from the bottom side of the tensioned film 330 to the top side of the tensioned film 330 due to the permeability of the tensioned film 330. The oxygen can be utilized to prevent the liquid photosensitive resin at the interface of the tensioned film 330 from being fully polymerized. To these ends, in some exemplary embodiments as shown in FIG. 10, a flow of air attributes to air channels such as air channels 350a, which may be indented on the top surface of the rigid substrate 350 and/or in the top surface of the tempered glass substrate 502 (e.g., micro-cracks when the tempered glass substrate may bow upward). The air can pass along the air channels 350a to the bottom side of the tensioned film 330. The air channels 350a may be extended and spaced apart from each other along the longitudinal and transverse directions of the rigid substrate 350 and/or the tempered glass substrate 502. In exemplary embodiments, the air channels 350 interconnect with each other so that the air or oxygen may be distributed uniformly at the bottom of the tensioned film 330; at the same time, rigid substrate 350 and/or the tempered glass substrate 502 may still provide a solid flat surface to support the tensioned film 330.

In some exemplary embodiments, air channels 350a may be formed by curving grooves on the top surface 350b of the rigid substrate 350 and/or the tempered glass substrate 502. Meanwhile, due to the texture on the sides of the tensioned film 330, when the tensioned film 330 sits on the tempered glass substrate 502, there still exist small gaps between the bottom side of the tensioned film 330 and the tempered glass substrate 502 at certain locations. These small gaps also facilitate the air flow between the tensioned film 330 and the tempered glass substrate 350 during printing.

A system 100 for three-dimensional printing, in accordance with exemplary embodiments of the present invention, may include: a computer 200 coupled to a light source 101 including instructions for selectively illuminating a photosensitive liquid in accordance with a geometric profile of a three-dimensional (3D) object, the light source for polymerizing the photosensitive liquid and forming a polymerized section of the 3D object; and a reservoir assembly 300 adapted to receive the light source 101, comprising: a top frame 320 having a cavity 322 with an aperture defined on a bottom edge of the top frame 320, the cavity 322 configured to be at least partially filled with the photosensitive liquid; a permeable tensioned film 330 stretchily coupled to the aperture so as to hold the photosensitive liquid within the cavity 322 of the top frame 320; a bottom frame 360 including a transparent or semi-transparent rigid substrate 350 beneath a tempered glass substrate 502, the bottom frame 360 configured to register with the top frame 320; and a media layer 330a sandwiched between the permeable tensioned film 330 and the tempered glass substrate 502 of the bottom frame 360.

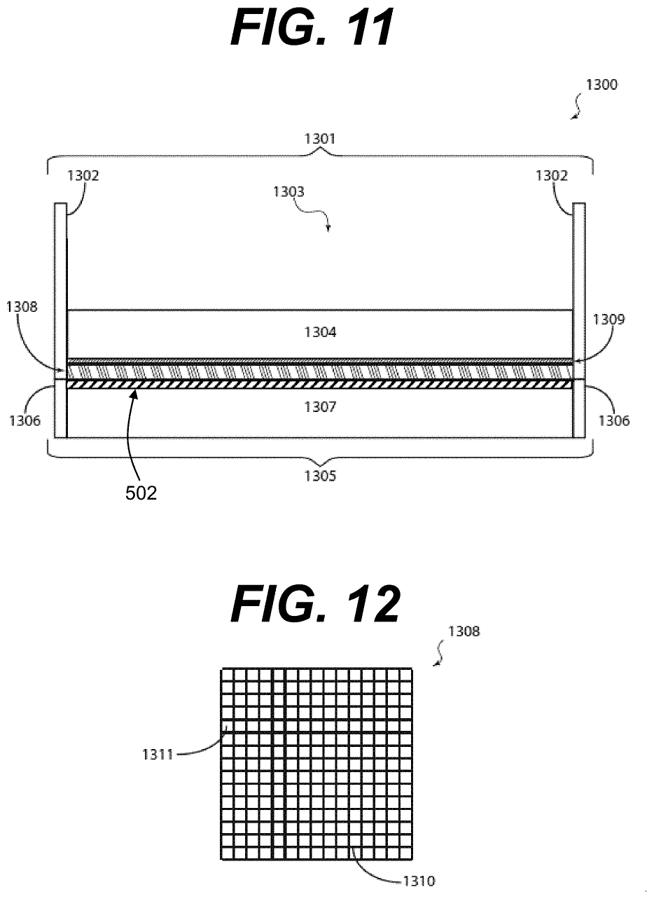

Turning to the next figures, another embodiment is presented. More specifically, FIG. 11 is a diagram showing an exemplary cross-section of a top frame coupled to a portion of a bottom frame of a reservoir assembly according to an exemplary embodiment of the present invention, and FIG. 12 illustrates an exemplary permeable substrate, which may be any type of substrate that is permeable or semi-permeable, such as a porous substrate or material in the form of a thin flexible sheet, or an interlaced structure such as a mesh or a flexible mesh that may be used, in some exemplary embodiments of the present invention, to reduce a separation force during a three-dimensional printing process.

In the embodiment of FIG. 11, reservoir assembly 1300 for use in three-dimensional printing, may include a top frame 1301 including side walls 1302, which in part form a cavity 1303 configured to be at least partially filled with a photosensitive liquid. The top frame 1301 includes an aperture defined on a bottom edge of the top frame 1301 between the side walls 1302. The aperture is sealed off with a film 1304 (that may a permeable film) stretchily coupled to the side walls 1302 and or to any other portion of or component of top frame 1301 in a manner so as to cover the aperture and thus adapted to hold the photosensitive liquid within the cavity 1303 of the top frame 1301. A bottom frame 1305 including side walls 1306 enclose a transparent or semi-transparent rigid substrate 1307, the bottom frame 1305 is configured to register with the top frame 1301. To significantly reduce a separation force during a three-dimensional printing process, a media layer such as a macro breathable membrane, including but not limited to a permeable substrate 1308, may be sandwiched between the top frame 1301 and the bottom frame 1305, and more specifically, sandwiched between the permeable film 1304 supported by the top frame 1301 and the tempered glass substrate 502 above the rigid substrate 1307 supported by the bottom frame 1305.

FIG. 12 illustrates an exemplary permeable substrate, and more specifically, an exemplary embodiment of permeable substrate 1308. Generally, permeable substrate 1308 provides a macro breathable membrane. In some exemplary embodiments, permeable substrate 1308 comprises of woven nylon strands that create an exceptionally fine mesh. In some exemplary embodiments, permeable substrate 1308 comprises a thin or ultra-thin paper mesh, for example a paper substrate made by Hidaka Washi. Different sizes and variations may be employed without deviating from the scope of the present invention. For example, and without limiting the scope of the present invention, permeable substrate 1308 may comprise of strands 1310 that have micro openings 1311. In some exemplary embodiments, each of the plurality of micro openings of the permeable substrate is between 85 to 95 microns. In some exemplary embodiments, a mesh size of the permeable substrate 1308 is between 80 to 200. In some exemplary embodiments, permeable substrate 1308 may comprise a mesh size of 198×198 wherein the strands 1310 are configured to form micro opening 1311 having an opening size of approximately 0.0035″ or 88.9 microns. In some embodiments, an ultra-thin paper material with a thickness less than 30 um and a weight density from 2 g/m2 to 34 g/m2 may be used as a flexible paper mesh.

As may be appreciated by a person of ordinary skill in the art, the many openings 1311 will have a total open area through which air may pass through the permeable substrate. In some exemplary embodiments, the total open area may be between 40% and 55%. In some exemplary embodiments, this open area comprises of approximately 49% of the total area. In some exemplary embodiments, the total open area may be between 80% and 90%, for example when a very thin paper or paper-like material is used. In exemplary embodiments, the diameter of strands 1310 may be approximately 0.0015″ or 38.1 microns. Typically, permeable substrate 1308 is a macro breathable membrane so that it looks opaque but when it comes in contact with light, it passes over 90% of light through. Generally, using permeable substrate 1308 as a proxy layer between the permeable film 1304 supported by the top frame 1301 and the rigid substrate 1307 supported by the bottom frame 1305 leads to a 5% -10% reduction of suction forces during the polymerization, thus making the printing process much more efficient. In some exemplary embodiments, suction forces were reduced to ⅛^{th} of the force used without the permeable substrate 1308.

Implementation of permeable substrate 1308 may be achieved in any number of ways without deviating from the scope of the present invention. For example, and without limiting the scope of the present invention, in some embodiments, permeable substrate 1308 may be glued to at least a portion of the bottom or top frames. In some embodiments, permeable substrate 1308 may secured to at least a portion of the transparent or semi-transparent rigid substrate 1307 and/or to the tempered glass substrate 502. In some embodiments, permeable substrate 1308 may secured to at least a portion of the permeable film 1304. In some embodiments, permeable substrate 1308 may be simply cut to size of the aperture between walls 1302 of top frame 1301 and placed between the permeable film 1304 and the tempered glass substrate 502 such that the permeable substrate 1308 is sandwiched between the permeable film 1304 and the tempered glass substrate 502.

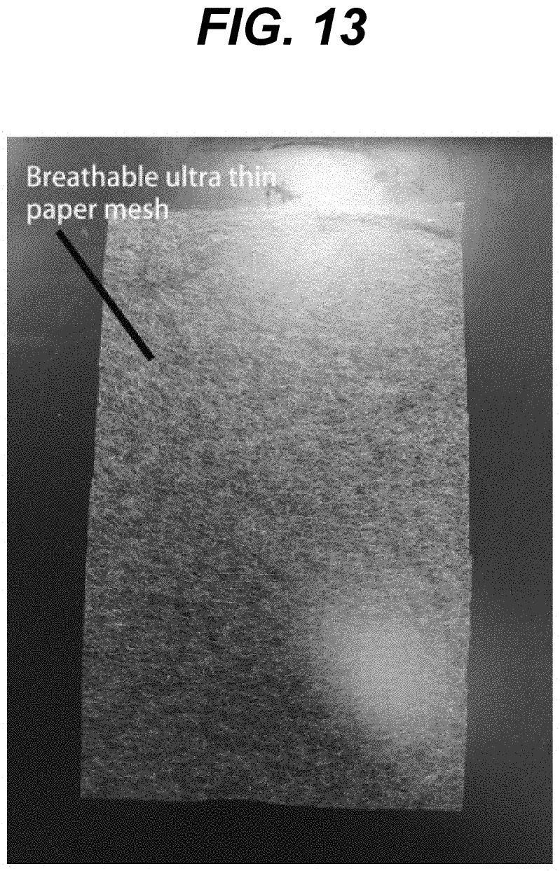

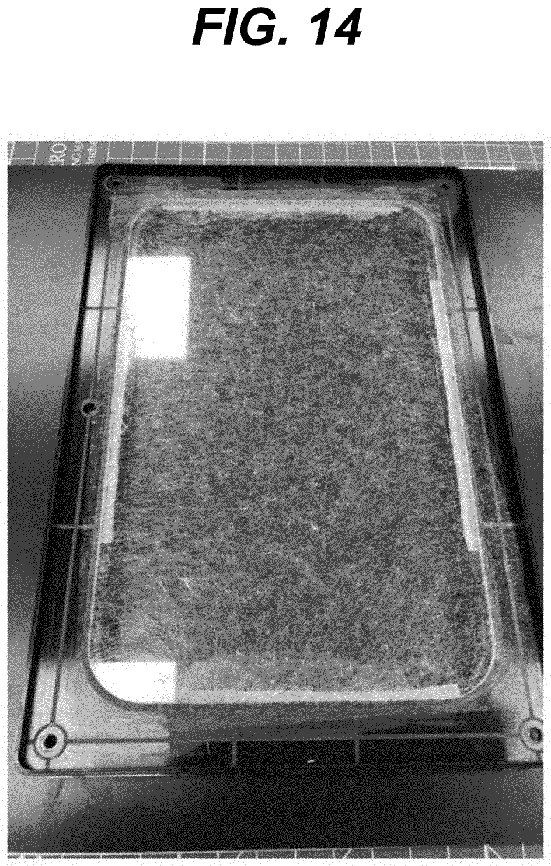

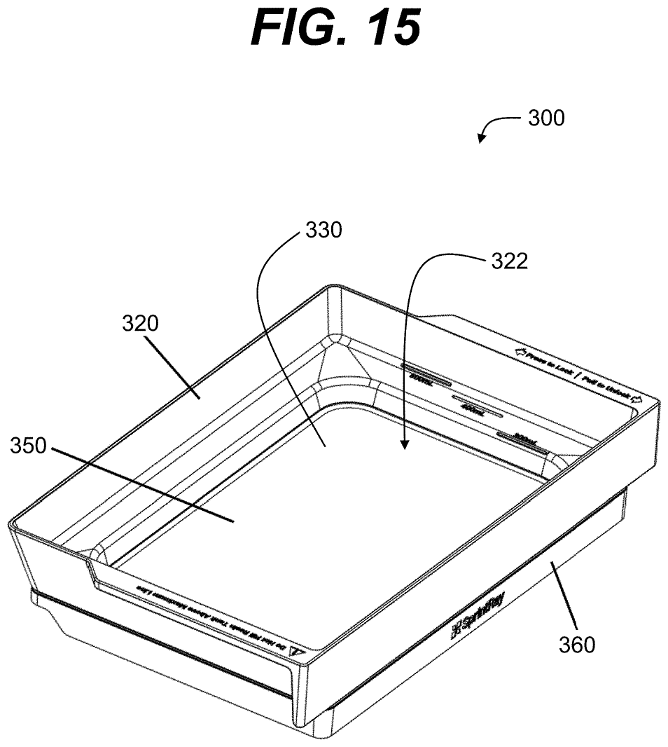

FIG. 13-FIG. 14 illustrate an exemplary permeable substrate and exemplary configuration in accordance with some exemplary embodiments of the present invention. More specifically, in the shown exemplary embodiment, a paper mesh may be used, which is constructed of a thin or ultrathin paper or paper substrate. For example, and without limiting the scope of the present invention, an ultra-thin paper mesh called Tengu from Hidaka Washi may be used. Regardless of the type or brand of paper material used, the ultra-thin paper mesh should create include a plurality of channels or channel-like structure (or otherwise microstructure) for air to breath in and out freely, during the polymerization and separation process. The microstructure allows a superior low suction force. In exemplary embodiments, the paper mesh is both transparent and flexible, with a thickness less than 30 um and a weight density from 2 g/m2 to 34 g/m2.

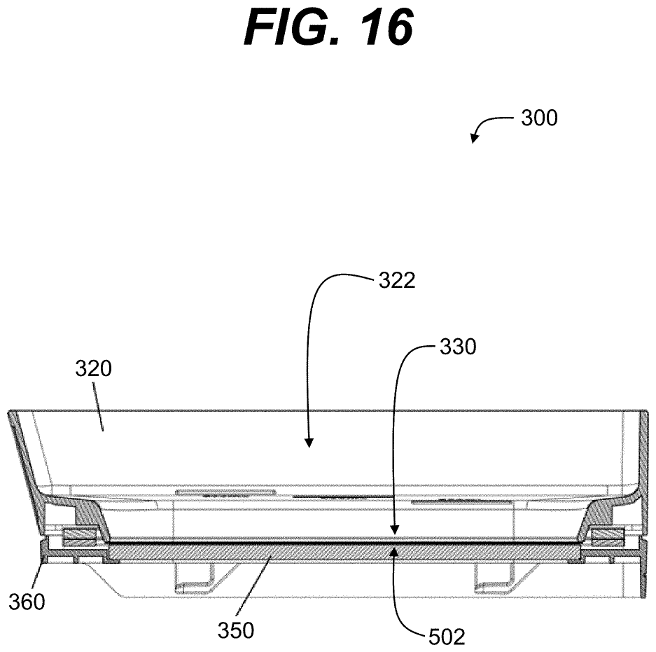

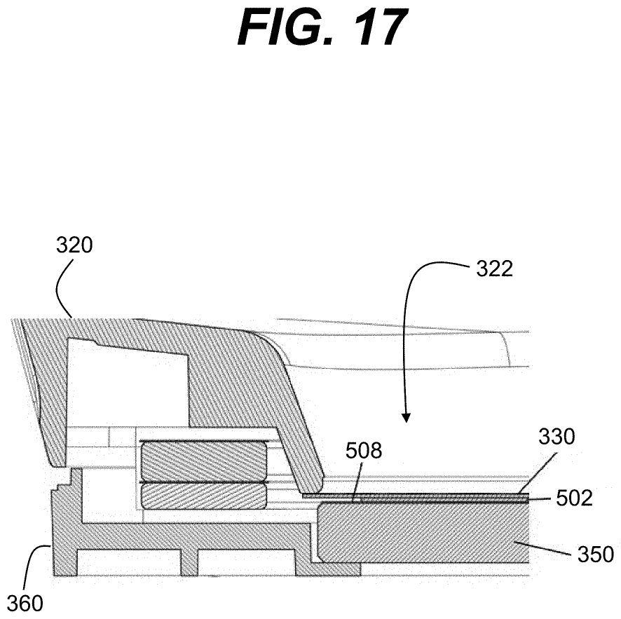

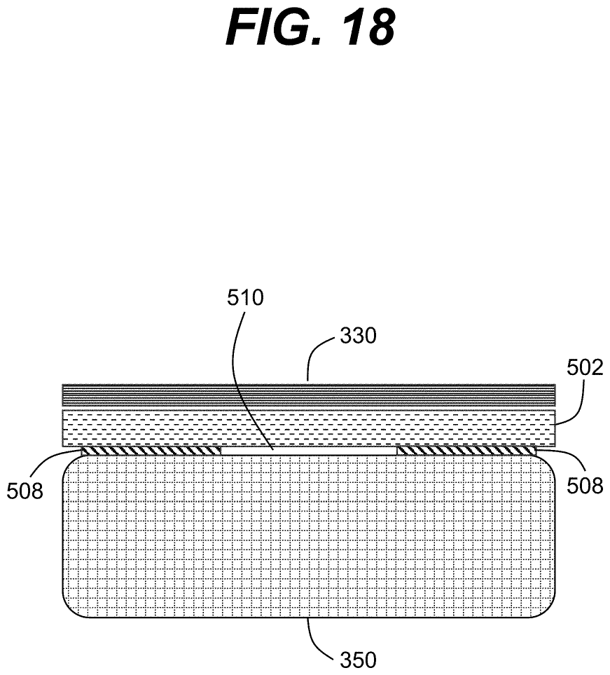

FIG. 15 shows a reservoir assembly 300 that generally corresponds to the reservoir assembly of FIG. 6 but with additional aspects as described below. FIG. 16 shows a side sectional view of the reservoir assembly of FIG. 15, and FIG. 17 shows a close-up view of a portion of FIG. 16.

In some embodiments, as shown in FIGS. 15-16, the reservoir assembly 300 includes a top frame 320 forming an inner cavity 322 and a tensioned film 330 forming a bottom of the cavity 322. As described herein, the cavity 322 is designed to hold a volume of photosensitive liquid used to form a 3D object during the 3D printing process. The reservoir assembly 300 also includes a bottom frame 360 configured beneath the top frame 320 and supporting a rigid substrate 350 (e.g., a glass substrate) positioned beneath the top frame's tensioned film 330.

In some embodiments, as shown in FIG. 17, a sheet of tempered glass 502 is disposed between the rigid substrate 350 of the bottom frame 360 and the tensioned film 330 of the top frame 320. In addition, one or more thin spacer members 508 are placed between the rigid substrate 350 and the tempered glass 502, e.g., at locations along the tempered glass's perimeter.

In some embodiments, the spacer members 508 may include sections of tape, film, paper, plastic, foam, rubber, wood, metal, composite materials, other types of suitable materials, and any combination thereof. In addition, it may be preferable that the spacer members 508 be optically clear and/or opaque, however, this may not be necessary. In some embodiments, the spacer members 508 have a thickness that maximizes both accuracy and separation speed. Accordingly, spacer members 508 are not too thick so as to affect printing accuracy, but they are not too thin so as to negatively impact separation force or speed.

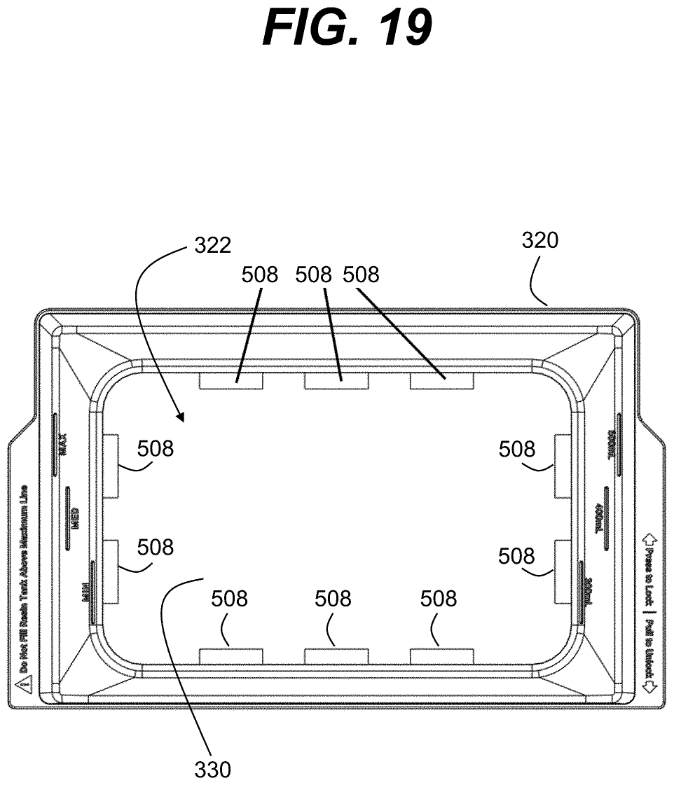

FIG. 18 shows a generalized block diagram representing the general arrangement of the rigid substrate 350, the spacer members 508, the sheet of tempered glass 502, and the tensioned film 330. It is understood that the dimensions are not to scale, and that FIG. 18 is meant to provide a general understanding of the spatial relationship between the spacer members 508, the rigid substrate 350, the tempered glass 502, and the tensioned film 330. As shown, the spacer members 508 form small gaps 510 between the substrate 350 and the sheet 502 in the areas where the spacer members 508 are not present. In some embodiments, the gaps 510 provide channels for air (and/or other gasses) to flow between the rigid substrate 350 and the tempered glass 502. This in turn lessens the suction force between the substrate 350 and the sheet 502 and the separation force necessary to separate the tensioned film 330 and the tempered glass 502 during the separation process of the 3D printing system.

In some embodiments, some or all of the spacer members 508 may be secured (e.g., using adhesive or other securing techniques) to a top side of the rigid substrate 350, to the underside of the sheet of tempered glass 502, or to any combination(s) thereof. In other embodiments, some or all of the spacer members 508 may be generally unattached to both the rigid substrate 350 and the sheet of tempered glass 502 and may sit freely therebetween.

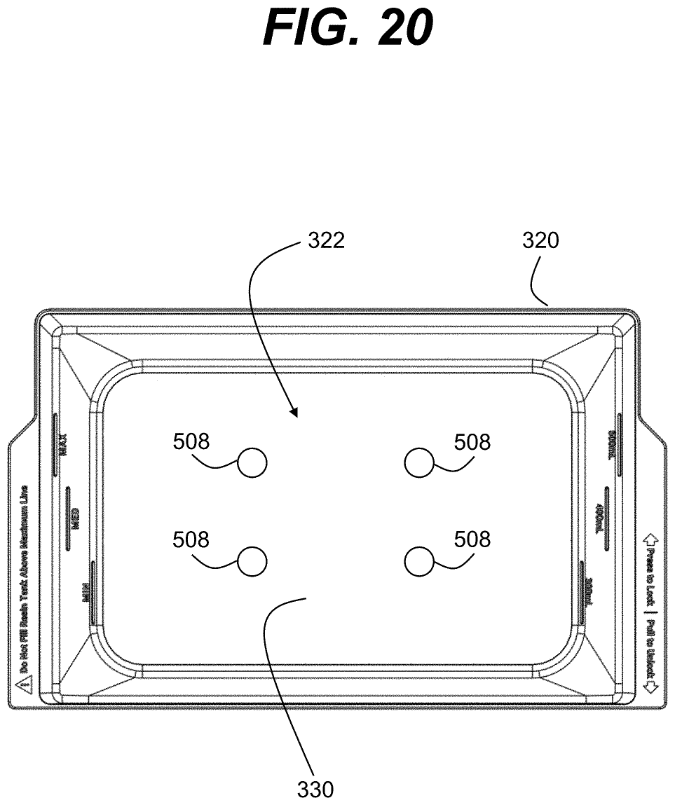

In some embodiments, as shown in FIG. 19, the spacer members 508 may be positioned at various locations with respect to the sheet of tempered glass 502. For example, in some embodiments, the spacer members 508 may be positioned at various locations along the perimeter of the tempered glass 502. For instance, in some embodiments, one or more sections of spacer members 508 may be positioned along the upper edge of the sheet 502 (as oriented as shown in FIG. 19), along the lower edge of the sheet 502, along the left edge of the sheet 502, and/or along the right edge of the sheet 502.

In some embodiments, as shown in FIG. 19, three spacer members 508 are positioned along the sheet's upper edge, with a first member 508 positioned generally at the midpoint between the left and right edges, a second member 508 positioned between first member 508 and the sheet's left edge, and a third member 508 positioned between the first member 508 and the sheet's right edge. In some embodiments, three additional spacer members 508 may be positioned along the sheet's lower edge generally mirroring the three spacer members 508 positioned along the sheet's upper edge. In addition, two spacer members 508 may be positioned along the sheet's left edge with a first spacer member 508 positioned at one-third the distance between the top and bottom edges and a second spacer member 508 positioned at two-thirds the distance between the top and bottom edges. Two additional spacer members 508 may be positioned along the sheet's right edge generally minoring the members 508 along the sheet's left edge. In this example, the spacer members 508 are about 0.25″-1.0″ wide and about 0.25″-3″ in length, but it is understood that the spacer members 508 may be of any suitable size.

In some embodiments, as shown in FIG. 20, the spacer members 508 may be positioned between the rigid substrate 350 and the sheet of tempered glass 502 at locations within the sheet's perimeter. Such spacer members 508 may provide gaps 510 for air flow while providing interior support to the sheet 502. For example, in some embodiments, the spacer members 508 may be arranged in a rectangular formation within an inner region of the sheet's perimeter as shown.

It is understood that the example arrangements of the spacer members 508 described above are meant for demonstration and that any number of spacer members 508 may be positioned at any location(s) between the substrate 350 and the sheet of tempered glass 502, e.g., at any location along the perimeter of the tempered glass 502, at any location within the perimeter of the tampered glass 502, and at any combination(s) thereof. In addition, while the spacer members 508 in FIG. 19 are shown as generally rectangular and the spacer members 508 in FIG. 20 are shown as generally circular, it is understood that the spacer members 508 may be formed as any shape(s) (e.g., square, oval, etc.) and that that shape of different spacer members 508 need not match.

In other embodiments, two or more sheets of tempered glass 502 may be used in combination in a stacked arrangement. In addition, one or more sheets of tempered glass 502 may be used in combination with one or more sheets of semirigid plastic with the tempered glass sheets 502 and the sheets of plastic in a stacked arrangement. In some embodiments, spacer members 508 may be provided between the plurality of tempered glass sheets 502, between the plurality of plastic sheets, between the tempered glass sheet(s) 502 and the plastic sheets, and between any combinations thereof.

In some embodiments, the sheet of tempered glass 502 and/or the plastic sheets may include a thickness of about 100 microns to about 2-3 millimeters or more.

It is understood that any aspect and/or element of any embodiment of the system 10 described herein or otherwise may be combined with any other aspect and/or element of any other embodiment of the system 10 in any way to form additional embodiments of the system 10 all of which are within the scope of the system 10.

While the embodiments and alternatives of the invention have been shown and described, it will be apparent to a person skilled in the art that various other changes and modifications can be made without departing from the spirit and scope of the invention.

The foregoing detailed description has set forth various embodiments of the devices and/or processes by the use of diagrams, flowcharts, and/or examples. Insofar as such diagrams, flowcharts, and/or examples contain one or more functions and/or operations, it will be understood by those within the art that each function and/or operation within such diagrams, flowcharts, or examples may be implemented, individually and/or collectively, by a wide range of hardware, software, firmware, or virtually any combination thereof.

Those skilled in the art will recognize that it is common within the art to describe devices and/or processes in the fashion set forth herein, and thereafter use engineering practices to integrate such described devices and/or processes into other stereolithography or three-dimensional printing systems. That is, at least a part of the devices and/or processes described herein may be integrated into a stereolithography or three-dimensional printing system via a reasonable amount of experimentation.

The subject matter described herein sometimes illustrates different components contained within, or connected with, other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

All references, including but not limited to patents, patent applications, and non-patent literature are hereby incorporated by reference herein in their entirety.

An apparatus, system and method for three-dimensional printing has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

1. A substrate assembly for use with a three-dimensional printer reservoir, the reservoir including a frame defining a cavity adapted to be at least partially filled with a photosensitive liquid, the substrate assembly comprising:
a first layer comprising a permeable film adapted to be configured with a lower portion of the cavity and to hold the photosensitive liquid within the cavity;
a second layer comprising a rigid substrate and configured below the first layer;
a third layer comprising a sheet of semirigid material disposed between the first layer and the second layer; and
one or more spacer members disposed between the second layer and the third layer.

2. The substrate assembly of claim 1 wherein the semirigid material comprises tempered glass and/or plastic.

3. The substrate assembly of claim 1 wherein the one or more spacer members include at least one selected from the group: tape, film, paper, plastic, foam, rubber, wood, and metal.

4. The substrate assembly of claim 1 wherein the one or more spacer members are attached to an upper surface of the second layer and/or to a lower surface of the third layer.

5. The substrate assembly of claim 1 wherein the third layer includes a perimeter and an area within the perimeter, and the one or more spacer members are located at locations along the perimeter.

6. The substrate assembly of claim 4 wherein three spacer members are located along a first edge of the third layer, and three spacer members are located along a second edge of the third layer opposing the first edge, two spacer members are located along a third edge of the third layer, and two spacer members are located along a fourth edge of the third layer opposing the third edge.

7. The substrate assembly of claim 1 wherein the third layer includes a perimeter and an area within the perimeter, and the one or more spacer members are located at locations within the perimeter.

8. The substrate assembly of claim 1 wherein the one or more spacer members form air channels adjacent the spacer members between the second layer and the third layer.

9. The substrate assembly of claim 1 wherein the third layer is about 100 microns to about 3 millimeters thick.

10. A substrate assembly for use with a three-dimensional printer reservoir, the reservoir including a frame defining a cavity adapted to be at least partially filled with a photosensitive liquid, the substrate assembly comprising:
a first layer comprising a permeable film adapted to be configured with a lower portion of the cavity and to hold the photosensitive liquid within the cavity;
a second layer comprising a rigid substrate and configured below the first layer;
a third layer comprising tempered glass disposed between the first layer and the second layer; and
one or more spacer members disposed between the second layer and the third layer.

11. The substrate assembly of claim 10 wherein the one or more spacer members include at least one selected from the group: tape, film, paper, plastic, foam, rubber, wood, and metal.

12. The substrate assembly of claim 10 wherein the one or more spacer members are attached to an upper surface of the second layer and/or to a lower surface of the third layer.

13. The substrate assembly of claim 10 wherein the third layer includes a perimeter and an area within the perimeter, and the one or more spacer members are located at locations along the perimeter.

14. The substrate assembly of claim 13 wherein three spacer members are located along a first edge of the third layer, and three spacer members are located along a second edge of the third layer opposing the first edge, two spacer members are located along a third edge of the third layer, and two spacer members are located along a fourth edge of the third layer opposing the third edge.

15. The substrate assembly of claim 10 wherein the third layer includes a perimeter and an area within the perimeter, and the one or more spacer members are located at locations within the perimeter.

16. The substrate assembly of claim 10 wherein the one or more spacer members form air channels adjacent the spacer members between the second layer and the third layer.

17. The substrate assembly of claim 10 wherein the third layer is about 100 microns to about 3 millimeters thick.
